(19) United States
(12) Patent Application Publication
(10) Pub. No.: US 2005/0081104 A1
(43) Pub. Date: Apr. 14, 2005

(54) Test diversity software testing method and apparatus

(76) Inventor: Borislav Nikolik, Portland, OR (US)

Correspondence Address: BORISLAV NIKOLIK, 9226 NW BARTHOLOMEW DRIVE, PORTLAND, OR, 97229, US

(21) Appl. No.: 10/669,413

(22) Filed: Sep. 25, 2003

(51) Int. Cl. G06F 11/00

(52) U.S. Cl. 714/38

(57) ABSTRACT

An automatic testing technique generates test distribution report indicating the internal test diversity of a software program under test; a new measure used in assessing and improving the quality of testing. A set of source files, chosen for diversity analysis, is minimally parsed and minimally instrumented. The program under test containing these instrumented files is then typically executed multiple times with test inputs. For each execution, the instrumented code collects test distribution data. Based on the distribution data, a report is generated indicating internal condition, data, and path diversity of the program under test.

### REFERENCES

### U.S. Patent Documents

U.S. Pat. No. 5,121,489 June, 1992 Andrews 395/183
U.S. Pat. No. 5,193,180 March, 1993 Hastings 395/183
U.S. Pat. No. 5,455,936 October, 1995 Maemura 395/183
U.S. Pat. No. 5,604,895 February, 1997 Raimi 395/701
U.S. Pat. No. 5,640,568 June, 1997 Komatsu 395/705
U.S. Pat. No. 5,689,712 November, 1997 Heisch 395/183

### Other References

[ham90] D. Hamlet and R. Taylor, “Partition testing does not inspire confidence,” IEEE Trans. Software Eng., vol.16, pp. 206-215, December 1990.
[ham89] D. Hamlet, “Theoretical Comparison of Testing Methods,” Proc. ACM SIGSOFT 3^{rd} Symposium on Software Testing, Analysis, and Verification. ACM Press, December 1989, pp. 28-37.
[hua75] J. Huang, “An Approach to Program Testing,” ACM Computing Surveys, vol. 7, no. 3, pp.113-128, September 1975.
[rap85] S. Rapps and E. J. Weyuker, “Selecting Software Test Data Using Data Flow Information,” IEEE Trans. Software Eng., vol. SE-14, pp. 367-375, April 1985.
[cla89] L. Clarke, A. Podgurski, D. Richardson, and S. Zeil, “A Formal Evaluation of Data Flow Path Selection Criteria,” IEEE Trans. Software Eng., vol. 15, pp. 244-151, November 1989.
[mey79] Meyers, The Art of Software Testing (Wiley 1979).
[bei90] Beizer, Software Testing Techniques (Van Nostrand 1990).
[how87] Howden, Functional Program Testing and Analysis (McGraw Hill 1987)
[per86] Perry, How to Test Software Packages (Wiley 1986).
[dem78] R. A. DeMillo, R. J. Lipton, and F. G. Sayward, “Hints on test data selection: Help for the practicing programmer,” Computer, vol. 11, pp. 34-41, April 1978.

### FIELD OF THE INVENTION

The invention relates to computer software testing, and more particularly to measuring internal coverage of software testing.

### BACKGROUND OF THE INVENTION

An important aspect of software engineering is software quality, which is crucial for safety-critical software where human lives and safety are at stake; however, its importance is also stressed by software development and quality organizations in non safety-critical commercial software. Due to its relative simplicity and reliability, the predominant method for software quality in the industry is run-time software testing, where the program under test is executed with test inputs in hope of finding software defects [how87].

Exhaustive testing, where software is tested with all possible inputs, user scenarios, and workflows, is infeasible except for trivial software, which is hard to find even in software textbooks. The task of selecting test cases that maximize the probability of exposing defects, from a potentially infinite exhaustive pool of test cases, is a difficult task that is believed to require a combination of art, science and discipline [mey79]. One of the ways to evaluate the effectiveness of this test selection is to measure the internal software code coverage that a test gives [bei90]. The reasoning behind code coverage is the fact that code that is not covered (unexecuted) might contain a defect that goes undetected if the portion of the code where the defect is located is not covered [dem78].

Code coverage has been around for a few decades now. A large body of literature has been published on the subject, and coverage test tools have been built and used in the software industry. Software test data adequacy criteria, based on code coverage, have been developed in order to determine when the software is ready for release. These test data adequacy criteria are based on control flow analysis [hua75], on data flow analysis [rap85], program mutation [dem78], and some combination of these. These criteria have been compared based on certain relationships [cla89], as well as on their ability to expose defects relative to one another [ham90], [ham89]. Commercial coverage tools, such as Bull's Eye C Cover and Rational PureCoverage have been built to measure control flow test adequacy, where a test is required to execute all the statements in the code in order to obtain 100% statement coverage.

For a given program, specification, and a test adequacy criterion, there are a large number of test suites that satisfy a given adequacy criterion. Typically, some of these suits detect defects while others do not, and there is no way to tell a priori which ones do and which ones do not, since that knowledge would make software testing redundant. The current invention observes that the probability a test suite exposes defects will be higher if the test suite results in program executions that involve more control, data, and path diversity. The term “diversity” has commonly been used in the literature on fault tolerant systems; however, the notion of diversity in the current invention is unrelated to the same term used elsewhere. The key to test diversity is the notion of test distribution, which is obtained by analyzing the frequency of executing program code.

Obtaining and analyzing the frequency of executing program code has been around for decades in the fields of performance analysis and performance optimization. For example, performance optimization finds its targets for optimization by analyzing the frequency of code execution. The current invention targets, obtains, interprets, uses and acts on the frequency of code execution in an original way.

In accordance with this invention, it is observed that the test coverage could be unevenly distributed for a particular test suite. For example, the true branches in the code could be more heavily exercised than the false ones, when in general the true branches are not more likely to contain defects than the false ones given a uniform distribution of defects along program paths. In the case of a uniform defect distribution along program paths, the highest conditional diversity is achieved when the coverage is evenly distributed (balanced), when the test hits half of the time the true branches, and the other half of the time the false branches. Testing might be rebalanced to produce more adequate conditional diversity by adding more test cases, by reordering existing test cases, and by replacing existing test cases with new ones.

In accordance with this invention, we note the fact that coverage suffers from the problem of potentially covering program code with data that does not expose defects. Since in general there are multiple sets of data that could cover a program, ones that expose defects and others that do not, a program could be completely control-covered but, unfortunately, with data that does not expose defects. Therefore, it is highly desirable to know the internal data distribution involved in testing, to take steps to increase it, and to continually measure it, improve it, and diversify it. Higher internal program data diversity gives higher probability of the test exposing defects, than a lower data diversity which indicates the code is covered with the same data over and over again. However, measuring data diversity is difficult since it requires collecting and analyzing huge portions of the memory at many points in the code to the point of not being feasible.

In accordance with this invention, we observe that control and data are tightly related with respect to test diversity. For example, branch selection in the code is governed by values of program variables, and vice versa, the values of program variables are governed by branch selection. The current invention observes that if two test suites result in different conditional diversities, then the internal data states involved in the test suites are different, in turn, resulting in different data flowing throughout the program. In effect, conditional diversity, which is simple to obtain, can be used to measure data diversity.

The current invention not only measures diversity but also could force a particular diversity as the program under test executes. A test generator forces a balanced test (or a test distributed differently from the normal execution of the program) in order to test the error handling aspects of the program under test. The idea is that making the program to execute a branch that it would not take in its normal execution forces exposure of potential error handling lapses in the code.

The software testing literature contains various path test adequacy criteria, which are divided into two broad classes: control path adequacy criteria, and dataflow path adequacy criteria. The control path criteria focus their attention on the control flow of tests through the program, and dataflow criteria focus on interesting paths from some data aspect. The dataflow testing criteria do not have anything to do with the actual data that flows throughout the program, but only that certain syntactic and semantic dataflow requirements are met. For instance, the definition-use dataflow criterion requires covering of at least one path that connects a statement where a variable is assigned a value and a statement where the variable is used.

The current invention observes that conditional diversity is closely related to path diversity, that is, high conditional diversity results in high path diversity, since higher conditional diversity guarantees more uniform execution of program paths. However, conditional diversity does not contain in itself the notion of execution order, only the frequency of execution. In accordance with the current invention, path diversity is a new quality measure, which measures the gaps in logic coverage along an executed path. Combining path diversity, conditional, and data diversity gives a powerful combination of control completeness, variation of paths, and variation of data as the program executes.

In accordance with yet another aspect of the current invention, compact path traces are collected indicating the locations of conditional statements in the source files, and their true/false values on program paths as exercised by test suites. These compact traces are processed to determine that if a condition on a path evaluated to true, that path should also include the same condition evaluated to false, and vice versa. The percentage of conditions that satisfy this requirements for every path (and sub-path) in the program, give path diversity for the program per particular test suite.

In accordance with a further aspect provided by the present invention, to simplify the often difficult process of parsing in commercial coverage tools, the “smart parse” process does not do a full parse as is conventionally done, but executes a simple search for conditional statements in the code, which are easily located by keywords such as if, while, case, for, etc. This allows code fragments of various languages, parts of source files, full source files, or whole projects to be easily, efficiently, and uniformly parsed, since the general syntax on which the parse in the current invention relies, is very similar for different programming languages.

In accordance with another aspect of the current invention, to make the instrumentation as general as possible, a minimal, to-the-point instrumentation is used, by inserting a general coverage-distribution recording, test generating, and path recording function calls at conditional statements. The called function is located in a library, and is common for all conditional statements and all programming languages. The projects that use instrumented source files need only link to this library.

The current state of the art suggests using different parsers for different languages and dialects, a full parse of source code, and a different look of the instrumentation code in terms of its contents and location in the source code for different languages, dialects and platforms. This has unfortunately given a rise to coverage tools with constant parsing problems, and the need to purchase a version of the same tool or another tool for each individual language and platform. Unlike the state of the art, the current invention proposes a universal, to-the-point parse, and a universal instrumentation for all commercially significant languages and dialects.

In accordance with yet another aspect of the current invention, the collection of distribution data is immediate, unlike what is currently done in the state of the art. Currently, the coverage data is written to a permanent record either at the termination of the program or periodically as the program runs. The obvious problem with this approach is that one might want to analyze the coverage data at various points in the execution of the program, and the complete coverage data at that point in the execution might not be available. Also, the program might never reach the termination point, since some programs, such as operating systems, are designed to run continuously.

In the current invention, the permanent record is updated immediately after execution of every conditional expression, keeping up-to-date record of distribution data. This allows great flexibility in the analysis of distribution data, even as the program under test is still running, or it has crashed, or has terminated successfully. It also allows fine granularity of analysis, where the distribution data could be analyzed per individual test or even anywhere in the middle of a test by using a debugger to interrupt the execution of the program. The existing commercial tools do not work with the necessary effective coverage granularity; their scope of coverage is along the lines of “all or nothing.”

In accordance with another aspect of the current invention, to make the diversity analysis more precise and flexible, comments with the keyword ZOOM_BEGIN and ZOOM_END could be inserted into the code by a tester to delimit the scope of the analysis to the block of code delimited with these keywords. This allows the testing to zoom in to various code segments, and causes the reports to be simpler with less data, resulting in to-the-point quick analysis. This finds its application, for example, in cases where only new code—code inserted or modified since the last major version—should be covered. Additionally, the keywords NOT_ZOOM_BEGIN and NOT_ZOOM_END delimit section of code that need not be included in the diversity analysis.

### BRIEF SUMMARY OF THE INVENTION

One or more computer software source files, which are part of one or many projects, one or many executables, and/or one or many libraries, written in potentially different programming languages are selected for diversity analysis. Unlike a common parse, which parses the whole code, a “smart parse” process looks only for syntactical program constructs in these files, such as conditional statements easily recognized by keywords like if, while, do, for, switch, case, etc. If testing of parts of code is desired, zooming in is performed for obtaining fine diversity, where the parser only locates the conditional statements delimited by the zoom keywords: ZOOM_BEGIN and ZOOM_END.

After the parser locates a conditional statement, the instrumenter inserts a compact conditional distribution function call at that location in the code. The basic information about the conditional statement, such as the file name where it appears, the line number where it begins, and place holders for the number of times the conditional expression in that statement (as well as the conditional sub-expressions) evaluates to true/false, are kept in a data structure which, at the end of the parse process, is permanently recorded. The instrumenter also places glue code in the source files to link the implementation of the conditional distribution function placed at the conditional statements.

The instrumented source files are than compiled in their corresponding projects, and typically, executed many times with different test cases. The conditional distribution functions that were placed in the conditional statements keep track of the number of times conditional expressions evaluate to true/false by updating the permanent record of conditional statements, which were produced and initialized by the parse process. Additionally, the conditional distribution functions leave a permanent path trace of conditional expressions and their Boolean values, as they are being executed.

The permanent record for conditional statements that contains the true/false evaluation frequencies of the conditional expressions is used to calculate the conditional diversity at any point in the program execution. The conditional diversities are calculated by computing the distance between the actual true/false distribution for a conditional expression and the uniform distribution for the same conditional expression. The total diversity for a test case is calculated as the average of the individual conditional diversities.

The conditional diversities are used to calculate the data diversity by comparing the conditional diversities between test suites, or by comparing the conditional diversities of test cases form a test suite. The percentage of different control diversities gives data diversity. Higher data diversity means more internal data variation present in the program executions relative to the test suites.

Path diversity is calculated by traversing the path trace, which is a sequence of conditional-expression locations in the code coupled with the Boolean values of the conditional expressions at a particular evaluation. A path is (control) diverse when, anywhere from the path start to the end of the path, conditional expressions that evaluated to true also evaluate to false along that path, and vice versa. The percentage of such conditional expressions gives the path diversity for that particular path. The total diversity is calculated as the average of the diversity of the individual start points.

The conditional, data, and path diversity results are reported in an audible manner. The report contains conditional diversities for each conditional and sub-conditional expression, data diversity for test cases and test suites, and path diversity for all the executed paths. Multiple reports are used in making inferences about the added diversity value of the individual tests represented by these reports.

In summary, the current invention measures the quality of software testing in a novel way by calculating and using the quality measures of control, data, and path diversity. The current invention also introduces a novel way of parsing and instrumenting source code in order to collect the distribution data necessary to compute the quality measures. These quality measures are used to improve software quality.

### DETAILED DESCRIPTION OF THE INVENTION

The following section describes in detail the parts of the current invention.

Smart Parse

Program parsing is an established field of programming languages, which involves scanning the source program in order to check if the syntax of the source program is in accordance with the lexical and grammatical rules for the particular language. Every language and every dialect of a particular language has its own lexical and grammatical rules. For this reason, it could happen that projects parse with one compiler but not with others.

In accordance with the current invention, the “smart parse” concentrates on the immutable syntax of conditional statements that are identical in every dialect of a particular language, and that are almost identical across commercial programming languages such as C, C++, Java, Basic, and C#. For example, every if statement is identical in every dialect of C, C++, Java, and C# with respect to the fact that the statement starts with the keyword if, and encloses the conditional expression in “(“and”).” The same applies to the while, for and switch statements in these languages. In Basic every if statement is identical in every dialect with respect to the fact that it begins with the keyword “if,” and terminates the conditional expression with the keyword “then.”

The smart parse process, which is basically the same for every programming language and dialect there of, does not parse the whole code, but it scans the source files to find keywords involved in conditional statements. Some of these keywords in C, C++, Java, C#, and Basic are: if, while, for, do, case, and default.

The locations of these keywords are passed onto the instrumenter for inserting instrumentation code at these locations.

The parser also keeps count of the number of decisions in a multi branch conditional statement, such as a switch statement in C++, or select statement in Basic. This count is used in diversity calculation for multi branching conditional statements.

Instrument Conditional Statements

Program instrumentation has been around for a few decades now, commonly found in the fields of software performance, compilers and software testing. The instrumentation technique consists of inserting executable statements in the original program while not affecting the logic and data flow of the original program. The original program with the instrumentation statements is referred to as the “instrumented version.” The instrumented version is unavoidably more complex, and more time and memory consuming than the original version. The simplicity of the instrumentation in the current invention minimizes the complexity and the amount of memory necessary to run the instrumented version.

In accordance with the current invention, the instrumenter places a conditional distribution function calls around conditional expressions, along the lines of:
cd(exp, loc, sub-exp, gen, path),
   where exp is the conditional expression in the conditional statement, loc is the location of the conditional statement in the permanent record of conditional statements, sub-exp indicates the sequential location of the sub-expression (if exp is a sub-expression), starting at 1 from left (sub-expressions are delimited by logical operators such as “and” and “or”), gen is a true/false parameter indicating use of test generation or not, and path is a true/false parameter indicating use of path trace or not. The function cd returns a Boolean value; if gen is set to false, cd always returns the value of exp, else it returns a Boolean value from some distribution (usually uniform).

Let the following C if statement have a sequential location 56 in the permanent record of conditional statements, that is, 55 other conditional expressions in various source files encountered, sequentially parsed and instrumented up to this statement:
if (a>MAX∥f(b)==CN)

After conditional instrumentation, the if statement becomes:
if (cd(a>MAX∥f(b)==CN, 56,0,0,0))

After sub-conditional instrumentation, the if statement becomes:
if (cd(cd(a>MAX,56,1,0,0)∥cd(f(b)==CN,56,2,0,0),56,0,0,0))

After test-generation instrumentation, the if statement becomes:
if (cd(a>MAX∥f(b)==CN,56,0,1,0))

And finally after path instrumentation, the if statement becomes:
if (cd(a>MAX∥f(b)==CN,56,0,0,1))

The cd function increments the Boolean count of the record 56 in the permanent record, respective of the actual run-time Boolean value of its first parameter, that is, if the value is true, the true counter is incremented; otherwise, the false counter is incremented. When the third parameter is not false, the Boolean counts for the sub-expressions a>MAX and f(b)==CN are incremented depending on their actual Boolean values. The cd function returns the Boolean value of the expression passed as its first parameter, unless the fourth parameter is set to true, in which case cd returns Boolean values from a distribution different from the actual one for that expression.

The cd function records a trace of the Boolean values of the conditional expressions along paths, if the last parameter is set to true. For example, if the conditional statement above is located in some file comp_max.c, and the value of a>MAX∥f(b)==CN at a particular execution is true, the cd function outputs 12:78:1, where 12 is the numerical equivalent of comp_max.c, the if statement is located at line 78 in comp_max.c, and 1 represents the Boolean value true.

For multi branching conditional statements, such as switch or select statements, the cd function, with the exp value set to true, is inserted after each possible case in the switch statement. For example, after the instrumentation, some C switch statement at location 23 in the permanent record of conditional statements becomes:

```
switch(temp)
{
  case 1: cd(true,23,false,false,false);
    dist+=x;
    break;
  case 2: cd(true,24,false,false,false);
    dis*=x;
    break;
  default: cd(true,25,false,false,false);
    dis−=x;
}
```

The cd function in this case keeps track of the number of times each case (including the default) is being executed.

The implementation of cd could be in the native language and its source included as part of the project, or it could be implemented once and placed in a library, which instrumented projects link to.

Diversity Calculation

The notions of program and data diversities have commonly been used in the software fault tolerance literature. Program diversity refers to the method where multiple programs implementing the same specification execute on the same input in order to achieve higher quality of the produced output. Data diversity refers to the method where the same program executes on multiple equivalent inputs in order to achieve higher quality of the produced output. Unlike in the fault tolerance literature, in the current invention the notion of diversity refers to control and data distribution in the software with respect to a particular test suite.

### Conditional Diversity

Conditional diversity (given as Diversity below) for some conditional expression is calculated as a distance between the actual distribution for that expression from the uniform distribution for that expression (given as Average below). The total conditional diversity is calculated as the average of the individual diversities for the conditional expressions in the program, and it gives the overall quality of the test.
Average=(true hits+false hits)/2
Diversity=1−((|Average−true hits|+|Average−false hits|)/(true hits+false hits)

Conditional diversity is a measure between 0 and 1. Higher conditional diversity is desirable; it means that the test cases exercise the control of the program more uniformly since the true and false branch executions are more balanced. In terms of the executed paths in the program, higher conditional diversity means that path execution is more uniformly distributed. Low conditional diversity means that some paths get exercised much more often than others. For example, low conditional diversity could mean that paths taking true branches are exercised more than paths taking false branches. This is an obvious problem, since, in general, defects do not concentrate on the true branches.

Conditional expressions could contain sub expressions, which are conditional expressions joined with logical and and or operators. Conditional diversity for a sub-condition is calculated as a distance between the actual distribution for the sub-condition from the uniform distribution for that sub-condition. The conditional distribution for the whole conditional expression is the average of the diversities for each individual sub-condition. The total diversity is calculated as an average of the individual sub-conditional diversities for all the conditions in the program.

The conditional diversity for a branch (given as Diversity below) in a multi branching conditional statement (such as a switch statement in C++) is calculated as a distance between the uniform distribution (given as Average below) and the actual distribution for that branch, using the formulas below. The conditional diversity for the whole multi branch is calculated as the average of the diversities of the individual branches in the statement.

### Data Diversity

Data diversity is calculated as an average of the individual data diversities for each conditional statement. The individual data diversities are calculated as a percentage of test suites for which a conditional expression has distinct conditional diversities. If two test cases have different conditional diversities then they execute different paths in the code, which is only possible if different data flows throughout the program. Therefore, higher data diversity means that the internal-program data involved in testing is more diverse.

Formally, conditional diversity is expressed as a conditional diversity vector of real values, where each value in the vector is the conditional diversity of a particular conditional expression in the code. Executions of the program on multiple test suites give a conditional diversity matrix which consists of conditional diversity vectors, each vector corresponding to a particular test suite. Matrix operations could be performed on a diversity matrix; for instance, to give a distance vector, where each value in the vector is the average distance of conditional distributions for a particular conditional expression, or to give a data diversity vector, where each value in the vector is the data diversity of a particular conditional expression in the code.

### Path Diversity

Simple path diversity is the degree to which each path in the program trace is complete with respect to true/false values of conditional expressions in the conditional statements that are on that path. Let Tr be a path trace containing of a sequence of triplets along the lines of the sample below, where the file-name and line-number give the location of the conditional statement, and Boolean-value is the true/false value of that condition:
File-name: Line-number: Boolean-value

These triplets are ordered and their order reflects the execution order of conditional sexpressions in the program under test. A path start point is the first occurrence of a particular file-name:line-number couple in Tr. For each start point, if a triplet fn:ln:true occurs in Tr anywhere from the start point to the end of the sequence, the triplet fn:ln:false needs to appear, as well, for the path to be complete with respect to the condition at fn:ln. The path diversity is calculated as a percentage of conditional expressions that evaluate both to true and false on a path. The average of the path diversity measure for all the path start points gives total path diversity.

Use of Diversity

The diversity measures could be used to evaluate test suites, to improve test suites, and to create new test cases.

### Evaluate Test Suites

An important aspect of software testing is determining the quality of the test suite. The true/false evaluation frequencies of the conditional expressions in conditional statements, as used in calculating conditional diversity, are used to measure the quality of a test suite. Higher conditional diversity, where the frequencies of true/false evaluations are more uniformly distributed, indicates a better test suite since it exercises the program more evenly and is not heavily concentrated on particular portions of the code. Ideally, which might not always be possible, the conditional diversity should be at its maximum, in which case the true/false distribution for every conditional statement in the code is uniform. However, in general, deciding what the target conditional diversity should be is left to the tester who bases that decision on factors such as code size, code criticality, code complexity, etc.

Any particular test adequacy criterion can potentially have many test data that satisfy it. Currently, test coverage does not distinguish test cases that exercise the same portion of the code. In fact, test cases that exercise the same code are considered undesirable since they do not add any coverage. The current invention distinguishes test cases that exercise the same portion of the code in the following sense. If the conditional distributions of two test cases t₁ and t₂ that exercise exactly the same code are different, then they exercise the same code with different internal data.

In particular, the program state at some conditional statement cᵢ for a test case ti is the set of program variables and their corresponding values, denoted by s(cᵢt₁). Let d(cᵢt₁) be the conditional diversity of cᵢ for test case t₁. Then,
d(cᵢt₁)≠d(cᵢt₂) then s(cᵢt₁)≠s(cᵢt₂),
and also
s(cᵢt₁)≠s(cᵢt₂) then d(cᵢt₁)≠d(cᵢt₂),
which makes conditional diversity and data variation closely related.

Reasoning about data variations in the code has been a difficult problem, since the volume of data that needs to be analyzed and the frequency of analysis is overwhelming. In accordance with the current invention, data variations are inferred from conditional diversity, which is a measure simple to obtain.

Conditional diversity is useful in inferring the value of test suites in a variety of additional ways. For example, if t₁ and t₂ are two test suites and their total conditional diversities are
d(t₁)=x and d(t₂)=y,
then the overall diversity of the two test suites is
d(t₁t₂)>min(x,y).

This bound is useful when executing tests in isolation, in different test environment, and combining test results.

Conditional diversity could also be used in a production context, where an instrumented application is distributed to customers. The diversity reports produced by such a version give insight in the defects encountered in the field.

### Improve Test Suites

Diversity could be improved by improving conditional diversity, sub-conditional diversity, data diversity, and path diversity. All of these diversities could be improved-by adding new test cases, by changing the execution order of the test cases, and/or by changing existing test cases in order to exercise the branches with lower distributions. The conditional distribution is cumulative, that is, each consecutive test from a test suite updates the conditional distribution. Combining test suites with different distributions has an effect on the total distribution, and therefore on the total diversity.

Conditional, sub-conditional, data, and path diversities are related. For example, higher conditional diversity has a higher chance of giving higher sub-conditional and path diversity. Also higher conditional diversity means that the internal data causing the execution of the true and false branches is more equally represented. In general, sub-conditional diversity is more related to data diversity than is conditional diversity to data diversity.

### Create Test Cases

An important aspect of software development is error handling. Any software should anticipate errors of various sorts and handle them in a systematic way. This is commonly done with the use of error handlers and/or asserts. The current invention proposes an automatic and systematic way to test for error handling by generating values and substituting them for actual values in conditional expressions. This substitution causes wrong branches to be taken which results in the wrong computation to take place. The wrong computations should be handled by the program's error handling routines.

While the invention has been described in connection with what is presently considered a preferred embodiment, it is to be understood that the invention is not to be limited to the disclosed embodiment, but on the contrary, it is intended to cover various modifications included within the spirit of the presented claims.

1. A computer program testing method for collecting internal test distribution information, and for indicating test diversity throughout source files written in the same or different programming languages; the method includes the steps:
parsing and instrumenting the computer program to provide an instrumented computer program;
executing the instrumented computer program to generate a test-distribution record and a path trace; and
producing test diversity output using the test-distribution record and the path trace to indicate the internal conditional diversity, data diversity, and path diversity of the program.

2. A method of software testing as in claim 1 wherein the execute step involves:
dynamically updating a test-distribution record of true/false frequency counts associated with each conditional expression and sub-expression in the program;
dynamically updating a compact path trace consisting of the locations of the conditional expression in the code and their resulting Boolean values after they have been completely evaluated; and
possibility of altering the normal control flow of the program by discarding the resulting Boolean values of the conditional expression, dynamically generating Boolean values, substituting these generated values for the discarded ones, and continuing execution with the generated values.

3. A method of software testing as in claim 1 further including the step of producing an audible report indicating conditional, data, and path diversity for the program under test.

4. A method as in claim 1 wherein the step of producing a diversity output for conditional diversity includes the steps of:
calculating the conditional diversity for a conditional expression form a test-distribution record as a distance between the even distribution of true and false condition evaluations and the actual distribution for that expression;
calculating the sub-conditional diversity for a conditional expression form a test-distribution record as a distance between the even distribution of true and false sub-condition evaluations and the actual distribution for each sub condition in the expression;
calculating the average conditional diversity by averaging the conditional diversities for all the conditional expressions; and
calculating the average sub-conditional diversity by averaging the sub-conditional diversities for all the conditional expressions.

5. A method as in claim 4 wherein calculating the distance includes the steps of:
calculating a distance for a two-way conditional statement as
Average=(true hits+false hits)/2
Distance=1−((|Average−true hits|+|Average−false hits|)/(true hits+false hits); and
calculating a distance for a multi-branching conditional statement as
Average=(true hits+false hits)/2
Distance=1−((|Average−true hits|+|Average−false hits|)/(true hits+false hits);
where true hits is the number of hits for the particular branch, and false hits is total hits for the multi branch minus true hits for the particular branch.

6. A method as in claim 1 wherein the step of producing a diversity output for data diversity includes the steps of:
calculating the conditional diversities for each of a set of multiple test suites;
calculating the individual data diversity for each conditional expression as a percentage of test suites for which the conditional diversities for that conditional expression are distinct; and
calculating the total data diversity as the average of individual data diversities.

7. A method as in claim 1 wherein the step of producing a diversity output includes the step of calculating the path diversity from a compact path trace as a percentage of conditional expressions for which, if the conditional expression evaluated to true on a path, it also evaluated to false on the same path, and vice versa.

8. A method for parsing computer software as in claim 1 by only parsing conditional statements and isolating the conditional expression and conditional sub-expressions in the conditional statement.

9. A method to instrument computer software as in claim 1 by inserting a function call around the conditional expression and conditional sub-expressions in a conditional statement to:
dynamically evaluate conditional expressions and sub-expressions and immediately update the true/false counts based on the evaluation;
to dynamically produce a compact path trace of conditional expression locations and their values; and
to dynamically generate Boolean values, evaluate conditional expressions, discard the resulting Boolean value from the evaluation, and substitute the generated value for the discarded one.

10. A method as in claim 1 where the collection of distribution/trace data is cumulative, and where the permanent distribution records/traces are kept updated until they are initialized.

11. A method as in claim 1 where the permanent distribution records for different test runs are merged into a single permanent distribution record.

12. A method for software testing including the steps of:
(a) Maintaining a data structure indicating the number of times conditional expressions and sub-expressions in conditional statements evaluate to true/false;
(b) Upon reaching a conditional statement, evaluating the conditional expression and sub-expression and immediately updating the data structure;
(c) Reporting conditional diversities computed using the counts from the data structure as a distance between the even distribution and the actual distribution of counts;
(d) Maintaining a path trace containing execution paths represented as locations of the conditional expressions in the code coupled with the resulting Boolean values of the conditional expressions;
(e) Upon reaching a conditional statement, evaluating the conditional expression and immediately updating the path trace;
(f) Reporting path diversity computed using the path trace; and
(g) Reporting data diversity computed as an average of individual diversities, calculated as a percentage of test suites that have distinct conditional diversities for a conditional expression.

13. A test generation method as in claim 12 where the steps (a)-(g) apply to program executions where the Boolean values, that resulted from complete evaluation of the conditional expressions, might be substituted with different Boolean values.

14. A method as in claim 12 wherein steps (c) and (f) further include prioritization of diversities by sorting the diversities according to worse diversity order, and limiting their number in the diversity report to the top few worst diversities.

15. A method of software testing including the steps of:
(a) Automatic parsing of a computer program to locate conditional statements and conditional expressions within the conditional statements;
(b) Automatic insertion of instrumentation code around conditional expressions and sub-expressions;
(c) Execution of an instrumented program, including the step of generating conditional distribution data for each conditional expression and sub-expression, and including the step of generating a path trace;
(d) Computing conditional, data and path diversities from the distribution data and the path trace; and
(e) Reporting conditional, data and path diversities in an immediate, audible manner.

16. Software testing apparatus comprising of an instrumenter that accepts source files of different languages as input, parses the files, inserts instrument code at the conditional expression in conditional statements to provide instrumented source files; an executor that executes the program(s) containing the instrumented files, and generates conditional distribution and a path trace in response to the inserted instrument code; a conditional diversity calculator, which calculates conditional diversities from the conditional distribution and reports them; a data diversity calculator, which calculates data diversities from conditional diversities and reports them; and a path diversity calculator, which calculates path diversity from the path trace and reports them.

17. Apparatus as in claim 16 wherein the instrumenter inserts instrumentation code to automatically generate Boolean values and substitute these generated values for the actual values that result from complete evaluation of a conditional expression.

18. A storage medium comprising of means for storing an instrumented source files defining conditional statements; a means for storing a data structure indicating the true/false counts for the values of conditional expressions, and means for storing path traces indicating the values of the conditional expressions along the paths; and a means for storing a further data structure indicating the top worst condition, data and path diversities.

19. A storage medium as in claim 18 wherein the means for storing an instrumented executable program(s) includes means for storing a function that updates the conditional expression and sub-expression true/false counts, updates the path trace as the instrumented program(s) run and encounter conditional statements, and generates test values for the conditional expressions as the instrumented program(s) run and encounter conditional statements.
